(19) United States
(12) Patent Application Publication
(10) Pub. No.: US 2016/0188899 A1
(43) Pub. Date: Jun. 30, 2016

(54) SECURITY ENHANCEMENT BASED ON USE OF ICONS WITH PASS CODES

(71) Applicant: OTIS ELEVATOR COMPANY, Farmington, CT (US)

(72) Inventors: Jannah A. Stanley, Portland, CT (US); Ashley Chapman, Plainville, CT (US); Tarique Faruki, Farmington, CT (US)

(21) Appl. No.: 14/896,559

(22) PCT Filed: Jun. 12, 2013
(86) PCT No.: PCT/US2013/045396

§ 371 Date: Dec. 7, 2015

(51) Int. Cl. G06F 21/62; G06F 17/30; G06F 3/0481; G06F 21/31; G06F 3/0484

(52) U.S. Cl. CPC G06F 21/6218; G06F 21/31; G06F 3/04842; G06F 3/04817; G06F 17/30914

(57) ABSTRACT

Embodiments are directed to receiving, by a computing device comprising a processor, a selection of an icon that corresponds to a request for access to at least one of a resource and an activity associated with a conveyance device, receiving, by the computing device, a pass code, determining, by the computing device, that the pass code corresponds to the icon, and causing, by the computing device, the requested access to be provided based on determining that the pass code corresponds to the icon.

### BACKGROUND

Changes in technology have enabled providers of goods and services to offer a rich feature set. For example, in connection with an elevator system, tenants and visitors to a building may obtain personalized elevator service. Instead of pressing traditional up and down buttons on a hall box and then pressing a floor number once inside an elevator, users of the elevator system may now enter destination floors using keypads or interactive touch screens before entering the elevator. The use of such technology may help to improve the flow of traffic in the building.

When accessing a resource, a person may typically enter a series or sequence of inputs to obtain access to the resource. For example, if personnel associated with the elevator system are to perform an activity (e.g., maintenance) in connection with the elevator, the personnel may be required to enter a preamble on an input device (e.g., a touchscreen) followed by a pass code. The preamble, which may take the form of depressing a specified key (e.g., a bottom-right key) on the input device a number of times (e.g., twice), is awkward and difficult to remember. Furthermore, the pass code is typically unrelated to the activity that is to be performed by the personnel, such that the personnel can enter the pass code without having to know what function or activity the pass code is associated with.

### BRIEF SUMMARY

An embodiment is directed to a method comprising: receiving, by a computing device comprising a processor, a selection of an icon that corresponds to a request for access to at least one of a resource and an activity associated with a conveyance device, receiving, by the computing device, a pass code, determining, by the computing device, that the pass code corresponds to the icon, and causing, by the computing device, the requested access to be provided based on determining that the pass code corresponds to the icon.

An embodiment is directed to an apparatus comprising: at least one processor, and memory having instructions stored thereon that, when executed by the at least one processor, cause the apparatus to: receive a selection of an icon that corresponds to a request for access to at least one of a resource and an activity associated with a conveyance device, receive a pass code, determine whether the pass code corresponds to the icon, and cause the requested access to be provided when it is determined that the pass code corresponds to the icon.

An embodiment is directed to an elevator system comprising: a user interface, and a computing device coupled to the user interface and configured to: receive a selection of an icon from the user interface that corresponds to a request for access to at least one of a resource and an activity associated with an elevator of the elevator system, receive a pass code from the user interface, determine whether the pass code corresponds to the icon, and cause the requested access to be provided when it is determined that the pass code corresponds to the icon.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating an exemplary computing system in accordance with one or more aspects of this disclosure;

FIG. 2 illustrates an exemplary interface in accordance with one or more embodiments;

FIG. 3 illustrates a flow chart of an exemplary method in accordance with one or more embodiments;

FIG. 4 illustrates a mapping of icons to pass codes in accordance with one or more embodiments; and

FIG. 5 illustrates a mapping of pass codes to icons in accordance with one or more embodiments.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for providing conditional access to a resource. In some embodiments, access to a resource may be determined based on a selection of an icon coupled with an entry of a personal identification number, a username and/or password, a credential, etc., all generally referred to herein as a pass code. The icon may be representative of, or associated with, an operation or activity to be performed in connection with the resource. The pass code may be associated with the operation or activity associated with the icon, and potentially one or more additional operations or activities.

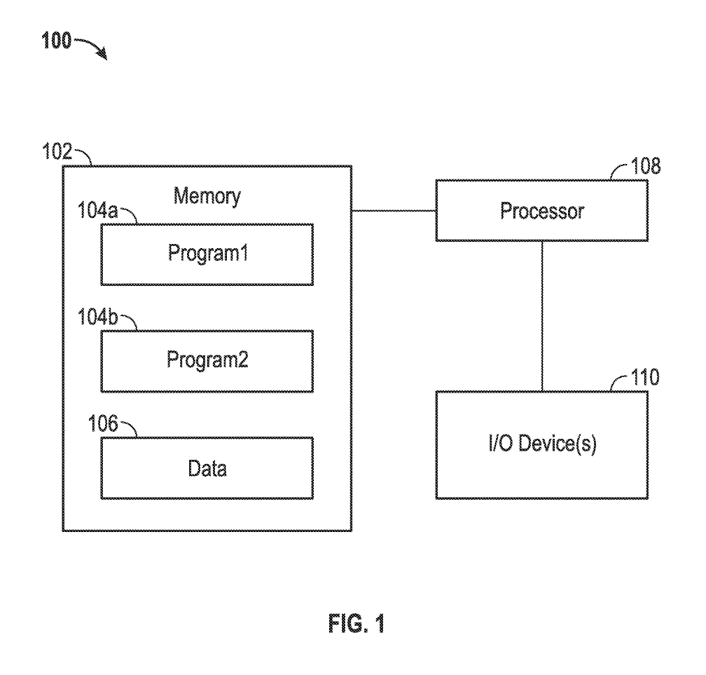

Referring to FIG. 1, an exemplary computing system 100 is shown. The system 100 is shown as including a memory 102. The memory 102 may store executable instructions. The executable instructions may be stored or organized in any manner and at any level of abstraction, such as in connection with one or more applications, processes, routines, procedures, methods, etc. As an example, at least a portion of the instructions are shown in FIG. 1 as being associated with a first program 104a and a second program 104b.

The memory 102 may store data 106. Data 106 may be indicative of one or more icons or pass codes as described herein. For example, data 106 may include data for associating an icon with one or more pass codes and data for associating a pass code with one or more icons. One or more icons may be associated with one or more activities.

The instructions stored in the memory 102 may be executed by one or more processors, such as a processor 108. The processor 108 may be coupled to one or more input/output (I/O) devices 110. In some embodiments, the I/O device(s) 110 may include one or more of a keyboard or keypad, a touchscreen or touch panel, a display screen, a microphone, a speaker, a mouse, a button, a remote control, a joystick, a printer, a telephone or mobile device (e.g., a smartphone), etc. The I/O device(s) 110 may be configured to provide an interface to allow a user to interact with the system 100.

The system 100 is illustrative. In some embodiments, one or more of the entities may be optional. In some embodiments, additional entities not shown may be included. For example, in some embodiments the system 100 may be associated with one or more networks, such as one or more computer or telephone networks. In some embodiments, the entities may be arranged or organized in a manner different from what is shown in FIG. 1.

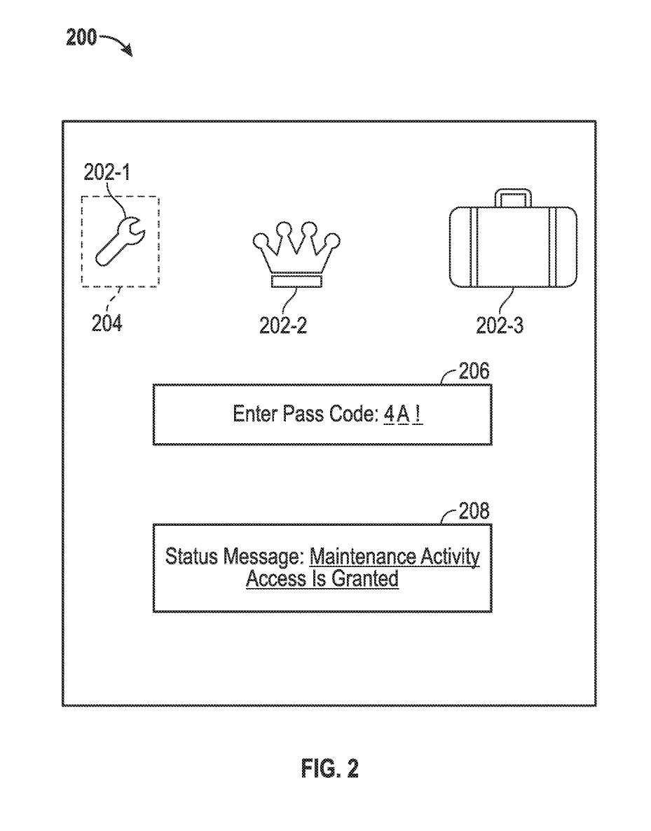

Turning now to FIG. 2, an exemplary interface 200 in accordance with one or more embodiments is shown. The interface 200 may correspond to a user interface. In some embodiments, the interface 200 may be implemented in connection with the system 100 (e.g., I/O device(s) 110). The interface 200 is illustratively described below as being implemented in connection with an elevator system.

The interface 200 is shown as including a number of icons 202-1, 202-2, and 202-3. The icon 202-1 may correspond to a wrench, which may be associated with a maintenance or repair activity in connection with the elevator system. The icon 202-2 may correspond to a crown, which may associated with a very important person (VIP) that may be the beneficiary of an empty car that directly takes the VIP to her destination floor or landing. In some embodiments, an icon (not shown in FIG. 2) may be used for a person that: (1) has vertigo, and (2) cannot be assigned to a glass elevator when riding in the elevator system. The icon 202-3 may correspond to a suitcase or luggage, and may be associated with a bellhop access to a freight elevator.

Of course, the type of icons shown for icons 202-1 through 202-3 is illustrative. Different icons may be used for the activities or functions described above. For example, an icon could include one or more of a graphical display, a word (e.g., “service”), etc. Furthermore, while only three icons are shown, in some embodiments more or fewer than three icons may be used or available.

As shown in FIG. 2, when a user selects an icon (e.g., icon 202-1), an indication 204 may be provided on the interface 200 to provide feedback or confirmation regarding the selection. While the indication 204 is shown in FIG. 2 as a dashed box, other types or formats for indicating an icon selection may be used. For example, highlighting, shading, blinking, motion/movement, display of a text message, a playing of an auditory sound, etc., may be used to indicate to a user that an icon has been selected.

Once an icon is selected, control may pass to an enter pass code field 206. In the enter pass code field 206, the user may have an opportunity to gain access to a resource specified by a selected icon. For example, assuming the selection of the icon 202-1 in FIG. 2, if a pass code corresponding to the icon 202-1 is successfully entered in field 206, then the user may be able to perform a maintenance or repair activity on the elevator. A pass code may include any number of characters, such as letters, number, symbols, etc. In some embodiments, a pass code may be entered using a graphical user interface (GUI), in an auditory fashion (e.g., spoken characters), or using any other input technique.

In the illustrative example of FIG. 2, a pass code of ‘4A!’ is considered to be a valid pass code for the icon 202-1, such that a status message 208 may indicate that ‘maintenance activity access is granted.’ Of course, the status message 208 could take any format, and may advise a user if the combination of the selected icon and entered pass code are incorrect, in which case access to the requested resource or activity may be denied.

While the sequence of events described above related to first selecting an icon (e.g., selecting icon 202-1) and then entering a pass code (e.g., pass code ‘4A!’), no particular order for the selection/entry is intended to be implied. For example, a user could first enter a pass code and then select an icon in order to successfully gain access to a resource or activity.

In some embodiments, multiple pass codes may be associated with a particular icon. For example, if employee identification numbers (ID #s) are assigned (e.g., randomly assigned) to employees, all employees within a building's maintenance or service department may have their employee ID #s associated with the icon 202-1, such that entering a service department employee ID # may serve to grant access to a maintenance or repair activity on the elevator when the icon 202-1 is selected. In this manner, the employees within the service department might not need to remember a specialized code, as their respective employee ID #s may suffice.

In some embodiments, a pass code may be associated with more than one icon. For example, an owner of the building in which the elevator is located may have her pass code associated with some or all of the icons 202. For example, the owner may have her pass code associated with the icons 202-1 and 202-3, such that the owner may obtain access to perform a maintenance or repair activity and may obtain access to a freight elevator.

In some embodiments, multiple pass codes may be associated with a particular icon, where each pass code may have a different function or activity. For example, pass codes ‘7B@’ and ‘8C%’ may each be associated with the icon 202-3. If pass code ‘7B@’ is entered, access to a freight elevator may be provided irrespective of whether the freight elevator is empty, partially loaded, or fully loaded. If pass code ‘8C%’ is entered, access to the freight elevator may be provided and the freight elevator may arrive at the landing where the user is located in an empty state or condition in order to accommodate a large cart that the user may be using to transport luggage.

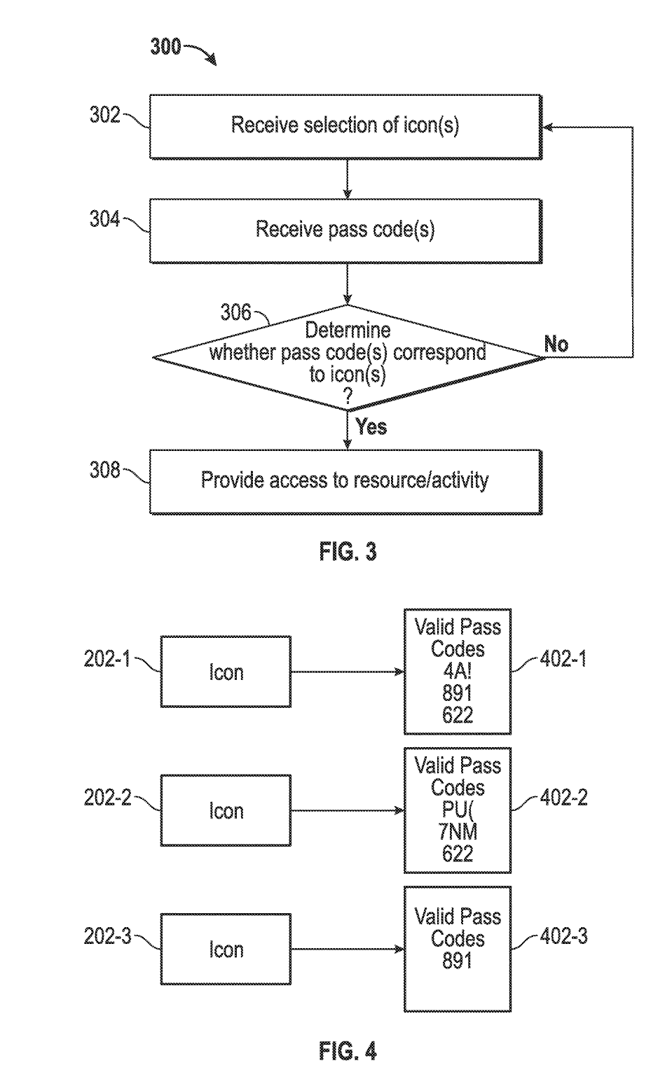

Turning now to FIG. 3, a flow chart of a method 300 in accordance with one or more embodiments is shown. The method 300 may be used in connection with one or more entities, devices or systems, such as those described herein. The method 300 may be used to obtain access to a resource or activity.

In block 302, a selection of one or more icons may be received. The selection(s) may be received in connection with an interface (e.g., a user interface). The icon(s) may be associated with one or more resources or activities.

In block 304, one or more pass codes may be received. The pass code(s) may be received in connection with an interface.

In block 306, a determination may be made whether the received pass code(s) of block 304 correspond to the selected icon(s) of block 302. Such a determination may be based on a comparison between: (1) the received pass code(s) and selected icon(s), and (2) a mapping of the icon(s) to pass code(s) stored as data in a memory (e.g., data 106 of memory 102).

If the received pass code(s) of block 304 correspond to the selected icon(s) of block 302 (e.g., the ‘Yes’ path is taken out of block 306), flow may proceed from block 306 to block 308. Otherwise (e.g., the ‘No’ path is taken out of block 306), flow may proceed from block 306 to block 302 (or block 304), and a status message (e.g., status message 208) to this effect may be provided, indicating that an incorrect icon and/or pass code has been selected/entered.

In block 308, access to the resource or activity may be provided or granted. A status message (e.g., status message 208) to this effect may be provided, indicating that the requested access has been granted.

The method 300 is illustrative. In some embodiments, one or more of the blocks or operations (or portions thereof) may be optional. In some embodiments, additional operations not shown may be included. In some embodiments, the operations may execute in an order or sequence different from what is shown.

Turning now to FIG. 4, an illustrative mapping of icons 202-1 through 202-3 to valid pass codes is shown. In the example of FIG. 4, icon 202-1 has associated with it valid pass codes 402-1 ‘4A!’, ‘891’, and ‘622’. In the example of FIG. 4, icon 202-2 has associated with it valid pass codes 402-2 PU(', ‘7NM’, and ‘622’. In the example of FIG. 4, icon 202-3 has associated with it valid pass codes 402-3 ‘891’.

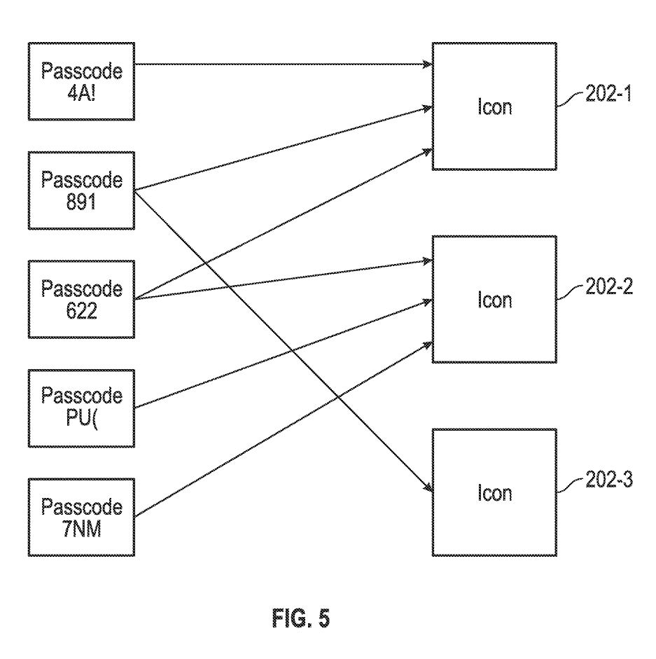

While the example of FIG. 4 related to mapping icons to pass codes that are valid for each icon, the opposite scenario may be used where pass codes are mapped to icons. Turning now to FIG. 5, an illustrative mapping of pass codes to icons corresponding to the mapping of FIG. 4 is shown. Thus, pass code ‘4A!’ is shown as mapping to icon 202-1, pass code ‘891’ is shown as mapping to icons 202-1 and 202-3, pass code ‘622’ is shown as mapping to icons 202-1 and 202-2, pass code ‘PU(’ is shown as mapping to icon 202-2, and pass code ‘7NM’ is shown as mapping to icon 202-2.

The mappings or combinations shown in FIGS. 4 and 5 may be stored as data (e.g., data 106) in a memory (e.g., memory 102). The mappings or combinations may be used in connection with the determination or comparison of block 306 of FIG. 3. The mappings or combinations may be modified to, e.g., accommodate changes to access rights or privileges.

Embodiments of the disclosure may enable a user to select an icon indicative of access to a resource or activity. Access may be granted upon successful entry of a pass code. Accordingly, the user might not be required to remember a preamble to engage the resource or activity and use may be made more intuitive. Also, having to choose an icon which corresponds to an entered pass code may provide an extra level of security, as the user may need to know not only the pass code but the type of operation the pass code is associated with.

While some of the examples described herein related to elevator systems, aspects of this disclosure may be applied in connection with other types of resources, such as other types of conveyance devices. Such conveyance devices may include one or more of a dumbwaiter, an escalator, a moving sidewalk, a wheelchair lift, etc.

Embodiments of the disclosure may be tied to one or more particular machines. For example, a selection of one or more icons may be received via an interface of a computing device. The computing device may receive one or more entered pass codes via the interface. The computing device may be configured to compare the combination of the selected icon(s) and entered pass code(s) with mappings or combinations of icons and pass codes to determine whether requested access to a resource or activity should be granted. The computing device may be configured to cause the requested access to be granted or provided or may deny the requested access.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method comprising:
receiving, by a computing device comprising a processor, a selection of an icon that corresponds to a request for access to at least one of a resource and an activity associated with a conveyance device;
receiving, by the computing device, a pass code;
determining, by the computing device, that the pass code corresponds to the icon; and
causing, by the computing device, the requested access to be provided based on determining that the pass code corresponds to the icon.

2. The method of claim 1, wherein the conveyance device comprises at least one of: an elevator, a dumbwaiter, an escalator, a moving sidewalk, and a wheelchair lift.

3. The method of claim 1, wherein the selection of the icon corresponds to a request to perform a maintenance activity.

4. The method of claim 1, wherein a plurality of pass codes map to the icon, and wherein the received pass code is included in the plurality of pass codes.

5. The method of claim 1, wherein the pass code maps to a plurality of icons, and wherein the icon is included in the plurality of icons.

6. The method of claim 1, wherein determining that the pass code corresponds to the icon comprises comparing a combination of the pass code and icon to a mapping of pass codes and icons.

7. The method of claim 1, wherein the pass code comprises at least one of: a personal identification number, a username, a password, a credential, and an employee identification number.

8. An apparatus comprising:
at least one processor; and
memory having instructions stored thereon that, when executed by the at least one processor, cause the apparatus to:
receive a selection of an icon that corresponds to a request for access to at least one of a resource and an activity associated with a conveyance device,
receive a pass code,
determine whether the pass code corresponds to the icon, and
cause the requested access to be provided when it is determined that the pass code corresponds to the icon.

9. The apparatus of claim 8, wherein the conveyance device comprises an elevator.

10. The apparatus of claim 8, wherein a plurality of pass codes map to the icon, and wherein the received pass code is included in the plurality of pass codes.

11. The apparatus of claim 8, wherein the pass code maps to a plurality of icons, and wherein the icon is included in the plurality of icons.

12. The apparatus of claim 8, wherein the instructions, when executed by the at least one processor, cause the apparatus to:
determine that the pass code corresponds to the icon by comparing a combination of the pass code and icon to combinations of pass codes and icons stored in the memory.

13. The apparatus of claim 8, wherein the pass code comprises at least one of: a personal identification number, a username, a password, a credential, and an employee identification number.

14. The apparatus of claim 8, wherein the instructions, when executed by the at least one processor, cause the apparatus to:
present a status message regarding whether the pass code corresponds to the icon.

15. The apparatus of claim 14, wherein the apparatus comprises a user interface, and wherein the status message comprises a message configured to be displayed on the user interface.

16. The apparatus of claim 8, wherein the apparatus comprises a user interface, and wherein the selection of the icon and the pass code are received via the user interface.

17. The apparatus of claim 16, wherein the user interface comprises a touch screen, and wherein the selection of the icon and the pass code are received via the touch screen.

18. An elevator system comprising:
a user interface; and
a computing device coupled to the user interface and configured to:
receive a selection of an icon from the user interface that corresponds to a request for access to at least one of a resource and an activity associated with an elevator of the elevator system,
receive a pass code from the user interface,
determine whether the pass code corresponds to the icon, and
cause the requested access to be provided when it is determined that the pass code corresponds to the icon.

19. The elevator system of claim 18, wherein the computing device is configured to determine that the pass code corresponds to the icon by comparing a combination of the pass code and icon to stored combinations of pass codes and icons.

20. The elevator system of claim 18, wherein the stored combinations of pass codes and icons are configured to be modified.
